(19) United States
(12) Patent Application Publication
(10) Pub. No.: US 2014/0043253 A1
(43) Pub. Date: Feb. 13, 2014

(54) MULTI-TOUCH SCREENS DEVICE AND METHOD OF OPERATING A MULTI-TOUCH SCREENS DEVICE

(71) Applicant: CHUNGHWA PICTURE TUBES, LTD., Taoyuan (TW)

(72) Inventors: Chia-Hua Chang, Changhua County (TW); Chao-Wei Wei, Taoyuan County (TW); Shu-Wen Chang, Taoyuan County (TW)

(73) Assignee: CHUNGHWA PICTURE TUBES, LTD., Taoyuan (TW)

(21) Appl. No.: 13/668,311

(22) Filed: Nov. 4, 2012

(30) Foreign Application Priority Data
Aug. 8, 2012 (TW) 101128557

(51) Int. Cl. G06F 3/041

(52) U.S. Cl. 345/173

(57) ABSTRACT

A multi-touch screens device includes at least two touch panels, a microprocessor, and an operation system. The microprocessor is coupled to the at least two touch panels for providing driving signals of the at least two touch panels to the at least two touch panels, receiving sensing signals generated by the at least two touch panels, and generating operation signals corresponding to the at least two touch panels according to the sensing signals. The operation system is coupled to the microprocessor for executing corresponding operations on the at least two touch panels according to the operation signals corresponding to the at least two touch panels.

### BACKGROUND OF THE INVENTION

1. Field of the Invention

The present invention relates to a multi-touch screens device and a method of operating a multi-touch screens device, and particularly to a multi-touch screens device and a method of operating a multi-touch screens device that can utilize one microprocessor to provide driving signals to at least two touch panels, and receive sensing signals generated by the at least two touch panels.

2. Description of the Prior Art

At present, touch panels have been widely used in consumer electronic products with advanced technologies, e.g. a tablet personal computer, a smart phone, a digital camera screen, and so on. In a consumer electronic product with touch panels, each touch panel is controlled by one microprocessor.

Please refer to FIG. 1 and FIG. 2. FIG. 1 is a diagram illustrating a notebook 100 with touch panels 102 and 104, and FIG. 2 is a diagram illustrating a digital camera 200 with touch panels 202 and 204. Therefore, as shown in FIG. 1 and FIG. 2, the notebook 100 needs to utilize two microprocessors to control the touch panels 102 and 104, and the digital camera 200 needs to utilize two microprocessors to control the touch panels 202 and 204. Thus, the prior art has higher cost, larger size, and higher design complexity due to wirings between each microprocessor and each touch panel.

### SUMMARY OF THE INVENTION

An embodiment provides a multi-touch screens device. The multi-touch screens device includes at least two touch panels, a microprocessor, and an operation system. The microprocessor is coupled to the at least two touch panels for providing driving signals of the at least two touch panels to the at least two touch panels, receiving sensing signals generated by the at least two touch panels, and generating operation signals corresponding to the at least two touch panels according to the sensing signals. The operation system is coupled to the microprocessor for executing corresponding operations on the at least two touch panels according to the operation signals corresponding to the at least two touch panels.

Another embodiment provides a method of operating a multi-touch screens device. The multi-touch screens device includes at least two touch panels, a microprocessor, and an operation system. The method includes the microprocessor providing driving signals of the at least two touch panels to the at least two touch panels; the microprocessor receiving sensing signals generated by the at least two touch panels; the microprocessor generating operation signals corresponding to the at least two touch panels according to the sensing signals; and the operation system executing corresponding operations on the at least two touch panels according to the operation signals corresponding to the at least two touch panels.

The present invention provides a multi-touch screens device and a method of operating a multi-touch screens device. The multi-touch screens device and the method utilize one microprocessor to provide driving signals of at least two touch panels to the at least two touch panels, receive sensing signals generated by the at least two touch panels, and generate operation signals corresponding to the at least two touch panels according to the sensing signals generated by the at least two touch panels. Therefore, compared to the prior art, the present invention has advantages as follows: first, wirings between the microprocessor and the at least two touch panels are significantly decreased; second, because the present invention only includes the microprocessor, the design complexity of the wirings between the microprocessor and the at least two touch panels is lower; third, because the present invention only includes the microprocessor, the present invention has lower cost; and fourth, because the present invention only includes the microprocessor, the present invention has smaller size.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a notebook with touch panels.

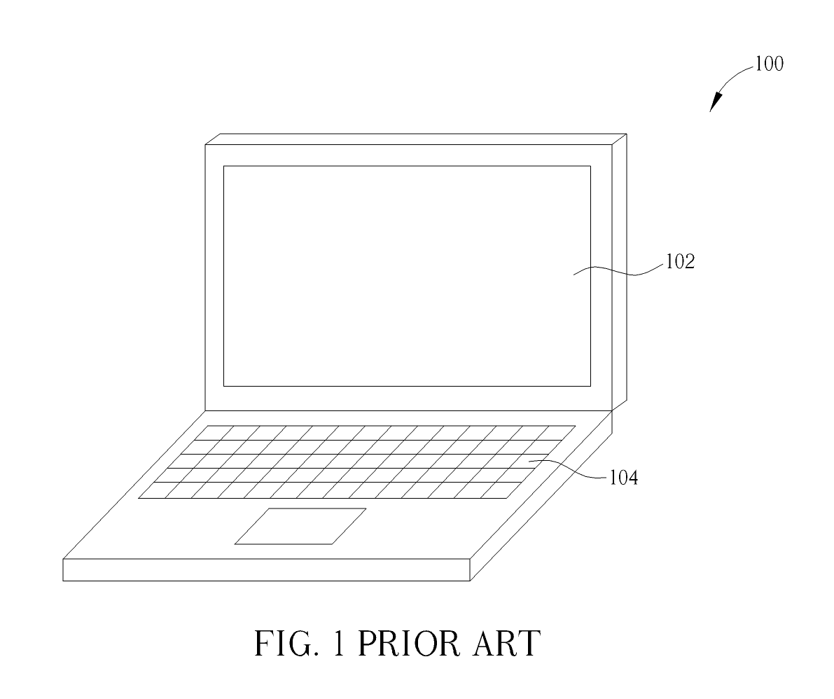

FIG. 2 is a diagram illustrating a digital camera with touch panels.

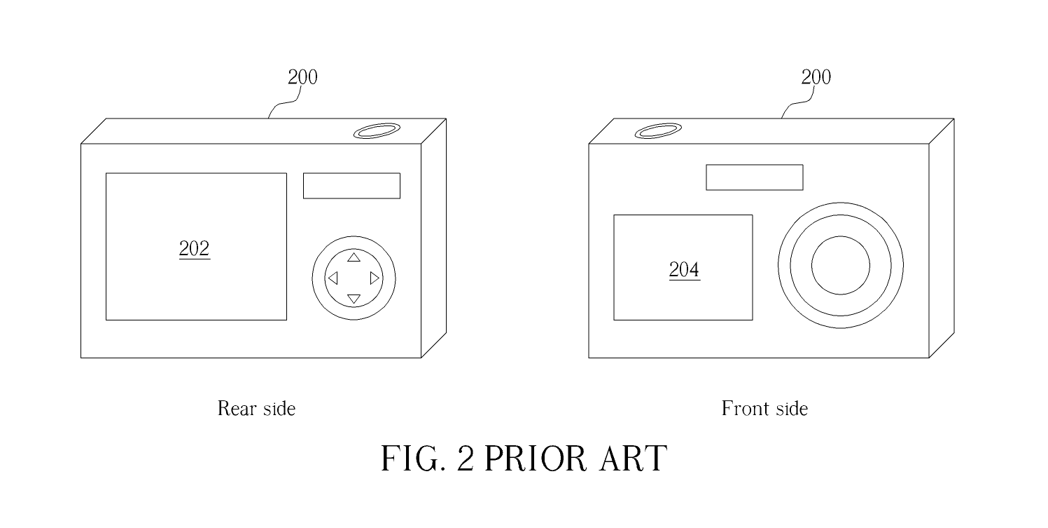

FIG. 3 is a diagram illustrating a multi-touch screens device according to an embodiment.

FIG. 4 is a diagram illustrating the touch panel.

FIG. 5 is a timing diagram illustrating a driving signal and a sensing signal.

FIG. 6 is a diagram illustrating a multi-touch screens device according to another embodiment.

FIG. 7 is a diagram illustrating a multi-touch screens device according to another embodiment.

FIG. 8 is a diagram illustrating a multi-touch screens device according to another embodiment.

FIG. 9 is a flowchart illustrating a method of operating a multi-touch screens device according to another embodiment.

FIG. 10 is a flowchart illustrating a method of operating a multi-touch screens device according to another embodiment.

FIG. 11 is a flowchart illustrating a method of operating a multi-touch screens device according to another embodiment.

FIG. 12 is a flowchart illustrating a method of operating a multi-touch screens device according to another embodiment.

### DETAILED DESCRIPTION

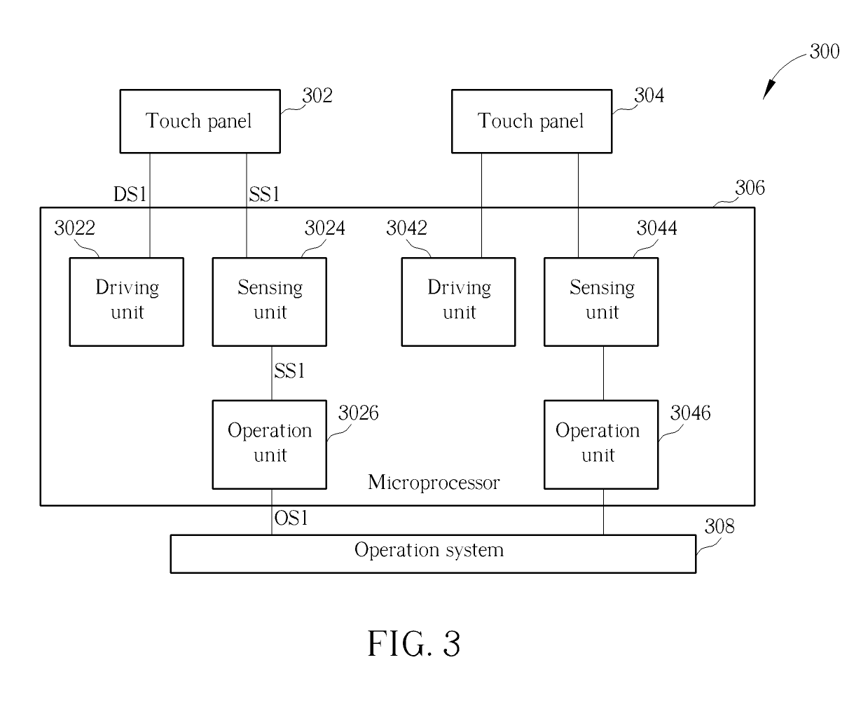

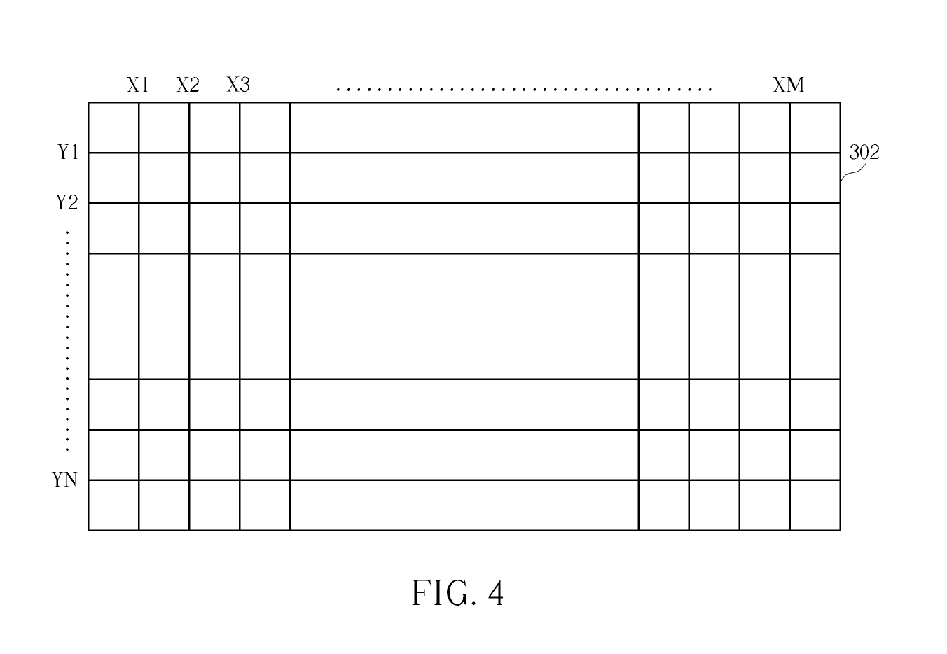

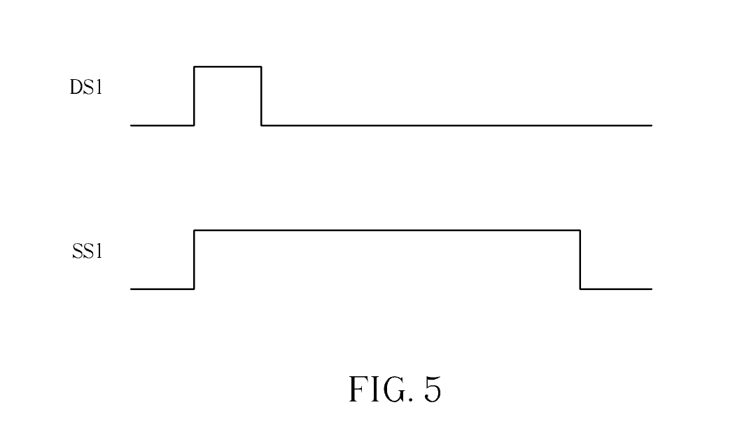

Please refer to FIG. 3. FIG. 3 is a diagram illustrating a multi-touch screens device 300 according to an embodiment. As shown in FIG. 3, the multi-touch screens device 300 includes two touch panels 302 and 304, a microprocessor 306, and an operation system 308. But, the present invention is not limited to the multi-touch screens device 300 including the two touch panels 302 and 304. That is to say, the multi-touch screens device 300 can include more than two touch panels. The microprocessor 306 is coupled to the touch panels 302 and 304, where the microprocessor 306 includes a driving unit 3022, a sensing unit 3024, and an operation unit 3026 corresponding to the touch panel 302, and a driving unit 3042, a sensing unit 3044, and an operation unit 3046 corresponding to the touch panel 304. Please refer to FIG. 4. FIG. 4 is a diagram illustrating the touch panel 302. As shown in FIG. 4, the touch panel 302 includes N driving lines Y1-YN, and M sensing lines X1-XM, where N and M are integers. The driving unit 3022 is used for providing driving signals corresponding to the touch panel 302 to the driving lines Y1-YN of the touch panel 302 in turn, and the sensing unit 3024 is used for receiving sensing signals generated by the sensing lines X1-XM of the touch panel 302 in turn. Please refer to FIG. 5. FIG. 5 is a timing diagram illustrating a driving signal DS1 and a sensing signal SS1. As shown in FIG. 5, when the driving unit 3022 provides the driving signal DS1 to the driving lines Y1 of the touch panel 302, the sensing unit 3024 can receive the sensing signal SS1 generated by the sensing lines X1-XM of the touch panel 302. In addition, the present invention is not limited to a method of the touch panel 302 detecting touch points in FIG. 5. That is to say, the present invention can utilize other methods of detecting touch points. Further, subsequent operational principles of other driving lines Y2-YN are the same as those of the driving line Y1, so further description thereof is omitted for simplicity.

As shown in FIG. 3, after the sensing signal SS1 is generated, the operation unit 3026 is used for generating an operation signal OS1 of the touch panel 302 according to the sensing signal SS1. The operation system 308 is coupled to the microprocessor 306 for executing corresponding operations on the touch panel 302 according to the operation signal OS1 of the touch panel 302. In addition, because the touch panel 304 is the same as the touch panel 302, so further description of the touch panel 304 is omitted for simplicity. As shown in FIG. 3, it is noted that the driving unit 3042 and the driving unit 3022 simultaneously provide the driving signals of the touch panels 302 and 304 to the touch panels 302 and 304, respectively, and the sensing units 3044 and 3024 simultaneously receive the sensing signals of touch panels 302 and 304, respectively. In addition, subsequent operational principles of the driving unit 3042, the sensing unit 3044, and the operation unit 3046 are the same as those of the driving unit 3022, the sensing unit 3024, and the operation unit 3026, so further description thereof is omitted for simplicity.

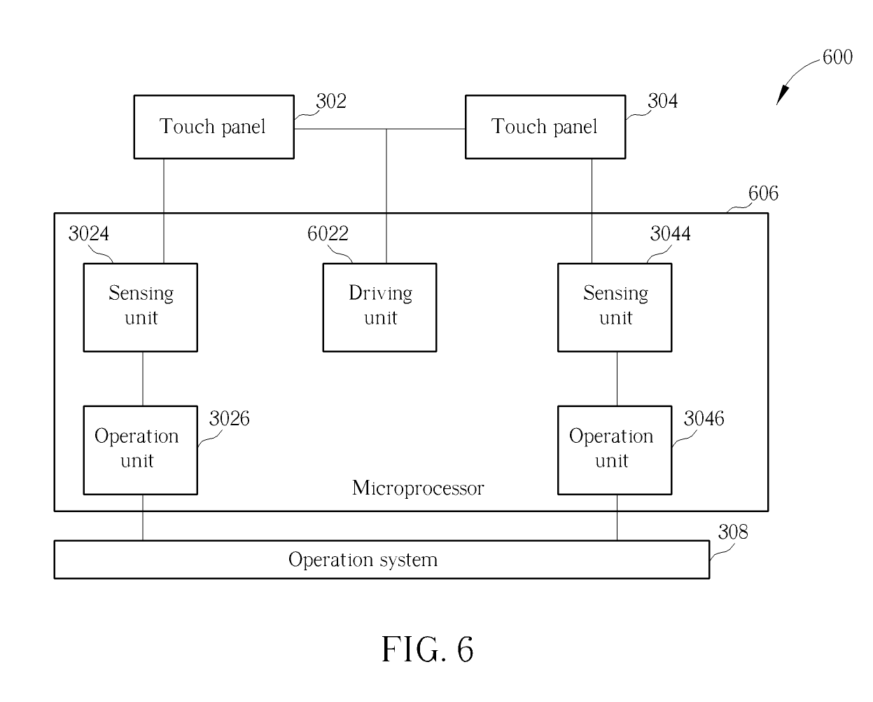

Please refer to FIG. 6. FIG. 6 is a diagram illustrating a multi-touch screens device 600 according to another embodiment. A difference between the multi-touch screens device 600 and the multi-touch screens device 300 is that a microprocessor 606 of the multi-touch screens device 600 includes a driving unit 6022 corresponding to the two touch panels 302 and 304, a sensing unit 3024 and an operation unit 3026 corresponding to the touch panel 302, and a sensing unit 3044 and an operation unit 3046 corresponding to the touch panel 304. Because the microprocessor 606 only includes the driving unit 6022, the driving unit 6022 is used for alternately providing driving signals of the touch panels 302 and 304 to the touch panels 302 and 304. Then, the sensing unit 3024 and the sensing unit 3044 simultaneously receive sensing signals generated by the touch panels 302 and 304, respectively. In addition, subsequent operational principles of the multi-touch screens device 600 are the same as those of the multi-touch screens device 300, so further description thereof is omitted for simplicity.

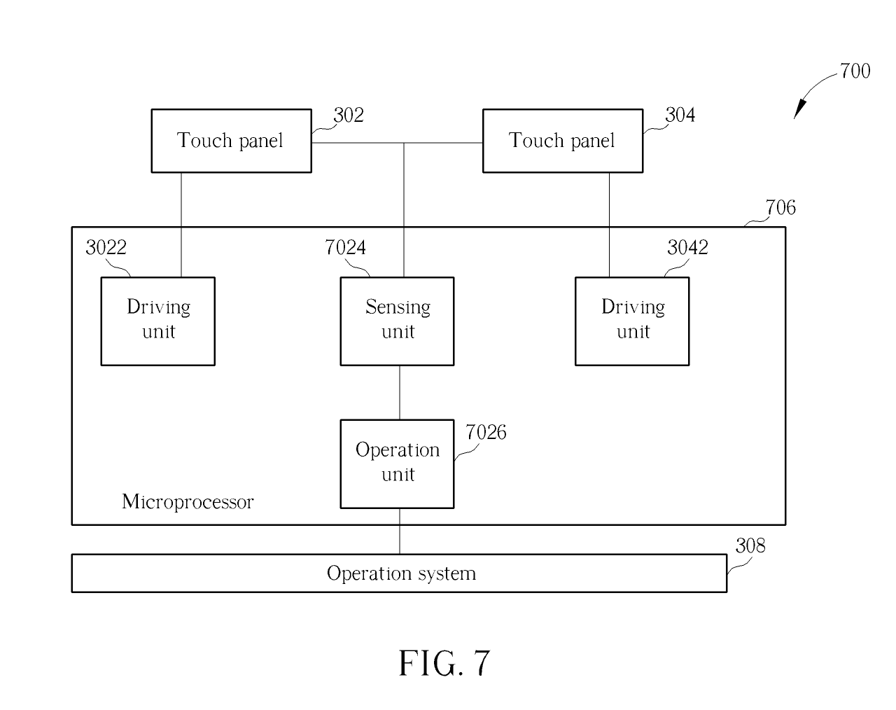

Please refer to FIG. 7. FIG. 7 is a diagram illustrating a multi-touch screens device 700 according to another embodiment. A difference between the multi-touch screens device 700 and the multi-touch screens device 300 is that a microprocessor 706 of the multi-touch screens device 700 includes the driving units 3022 and 3042 corresponding to the two touch panels 302 and 304, respectively, and a sensing unit 7024 and an operation unit 7026 corresponding to the two touch panels 302 and 304. Because the microprocessor 706 includes the driving units 3022 and 3042 corresponding to the two touch panels 302 and 304, respectively, the driving units 3022 and 3042 are used for simultaneously providing driving signals of the touch panels 302 and 304 to the touch panels 302 and 304, respectively. Because the sensing unit 7024 corresponds to the two touch panels 302 and 304, the sensing unit 7024 is used for alternately receiving sensing signals generated by the touch panels 302 and 304. Because the microprocessor 706 only includes the operation unit 7026, the operation unit 7026 can alternately generate operation signals of the two touch panels 302 and 304 according to the sensing signals generated by the two touch panels 302 and 304. In addition, subsequent operational principles of the multi-touch screens device 700 are the same as those of the multi-touch screens device 300, so further description thereof is omitted for simplicity.

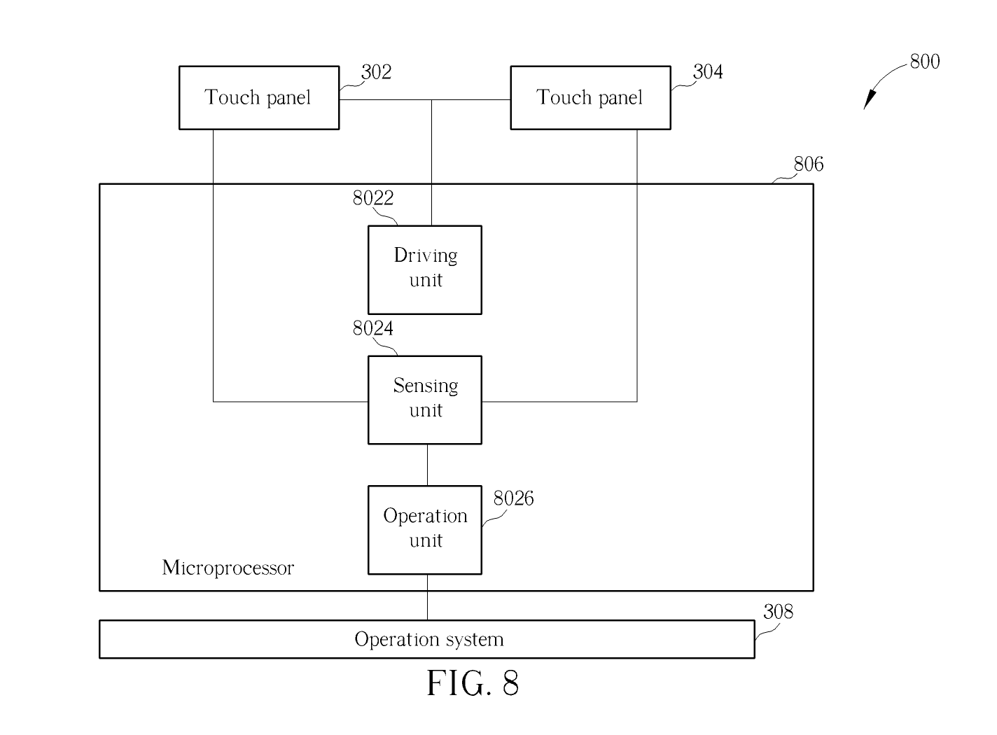

Please refer to FIG. 8. FIG. 8 is a diagram illustrating a multi-touch screens device 800 according to another embodiment. A difference between the multi-touch screens device 800 and the multi-touch screens device 300 is that a microprocessor 806 of the multi-touch screens device 800 includes a driving unit 8022, a sensing unit 8024, and an operation unit 8026 corresponding to the touch panels 302 and 304. Because the microprocessor 806 only includes the driving unit 8022, the driving unit 8022 is used for alternately providing driving signals of the touch panels 302 and 304 to the touch panels 302 and 304. Because the microprocessor 806 only includes the sensing unit 8024, the sensing unit 8024 is used for alternately receiving sensing signals generated by the touch panels 302 and 304. In addition, subsequent operational principles of the multi-touch screens device 800 are the same as those of the multi-touch screens device 300, so further description thereof is omitted for simplicity.

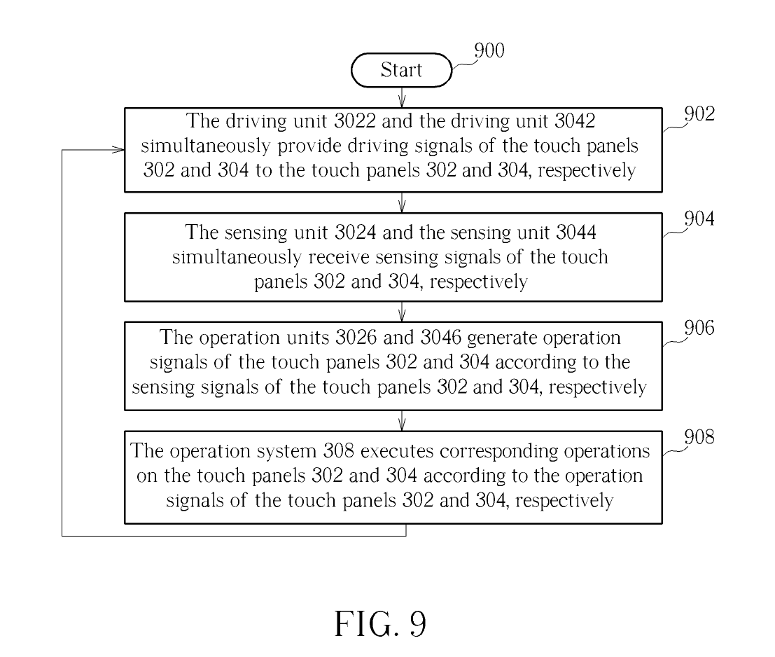

Please refer to FIG. 3, FIG. 4, FIG. 5, and FIG. 9. FIG. 9 is a flowchart illustrating a method of operating a multi-touch screens device according to another embodiment. The method in FIG. 9 is illustrated using the multi-touch screens device 300 in FIG. 3. Detailed steps are as follows:

Step 900: Start.

Step 902: The driving unit 3022 and the driving unit 3042 simultaneously provide driving signals of the touch panels 302 and 304 to the touch panels 302 and 304, respectively.

Step 904: The sensing unit 3024 and the sensing unit 3044 simultaneously receive sensing signals of the touch panels 302 and 304, respectively.

Step 906: The operation units 3026 and 3046 generate operation signals of the touch panels 302 and 304 according to the sensing signals of the touch panels 302 and 304, respectively.

Step 908: The operation system 308 executes corresponding operations on the touch panels 302 and 304 according to the operation signals of the touch panels 302 and 304, respectively; go to Step 902.

As shown in FIG. 4, the touch panel 302 includes the N driving lines Y1-YN, and the M sensing lines X1-XM. In addition, because the touch panel 304 is the same as the touch panel 302, the touch panel 304 also includes N driving lines and M sensing lines. In Step 902, the driving unit 3022 and the driving unit 3042 simultaneously provide the driving signals of the touch panels 302 and 304 to the N driving lines Y1-YN of the touch panels 302 and the N driving lines of the 304 in turn, respectively. In Step 904, the sensing unit 3024 and the sensing unit 3044 simultaneously receive the sensing signals generated by the touch panels 302 and 304 in turn, respectively. For example, as shown in FIG. 5, when the driving unit 3022 provides a driving signal DS1 to the driving lines Y1 of the touch panel 302, the sensing unit 3024 can receive a sensing signal SS1 generated by the sensing lines X1-XM of the touch panel 302. In addition, the present invention is not limited to a method of the touch panel 302 detecting touch points in FIG. 5. That is to say, the present invention can utilize other methods of detecting touch points. In Step 906, after the sensing signals of the touch panels 302 and 304 are generated, the operation units 3026 and 3046 can generate the operation signals of the touch panels 302 and 304 according to the sensing signals of the touch panels 302 and 304. Then, in Step 908, the operation system 308 can execute the corresponding operations on the touch panels 302 and 304 according to the operation signals of the touch panels 302 and 304, respectively.

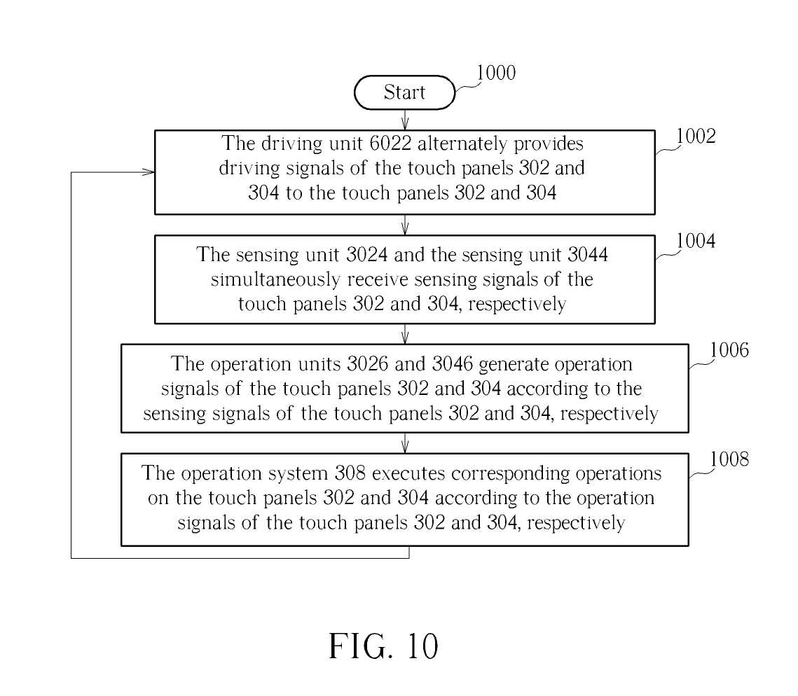

Please refer to FIG. 6 and FIG. 10. FIG. 10 is a flowchart illustrating a method of operating a multi-touch screens device according to another embodiment. The method in FIG. 10 is illustrated using the multi-touch screens device 600 in FIG. 6. Detailed steps are as follows:

Step 1000: Start.

Step 1002: The driving unit 6022 alternately provides driving signals of the touch panels 302 and 304 to the touch panels 302 and 304.

Step 1004: The sensing unit 3024 and the sensing unit 3044 simultaneously receive sensing signals of the touch panels 302 and 304, respectively.

Step 1006: The operation units 3026 and 3046 generate operation signals of the touch panels 302 and 304 according to the sensing signals of the touch panels 302 and 304, respectively.

Step 1008: The operation system 308 executes corresponding operations on the touch panels 302 and 304 according to the operation signals of the touch panels 302 and 304, respectively; go to Step 1002.

A difference between the embodiment in FIG. 10 and the embodiment in FIG. 9 is that in Step 1002, because the microprocessor 606 only includes the driving unit 6022, the driving unit 6022 alternately provides the driving signals of the touch panels 302 and 304 to the touch panels 302 and 304. In addition, subsequent operational principles of the embodiment in FIG. 10 are the same as those of the embodiment in FIG. 9, so further description thereof is omitted for simplicity.

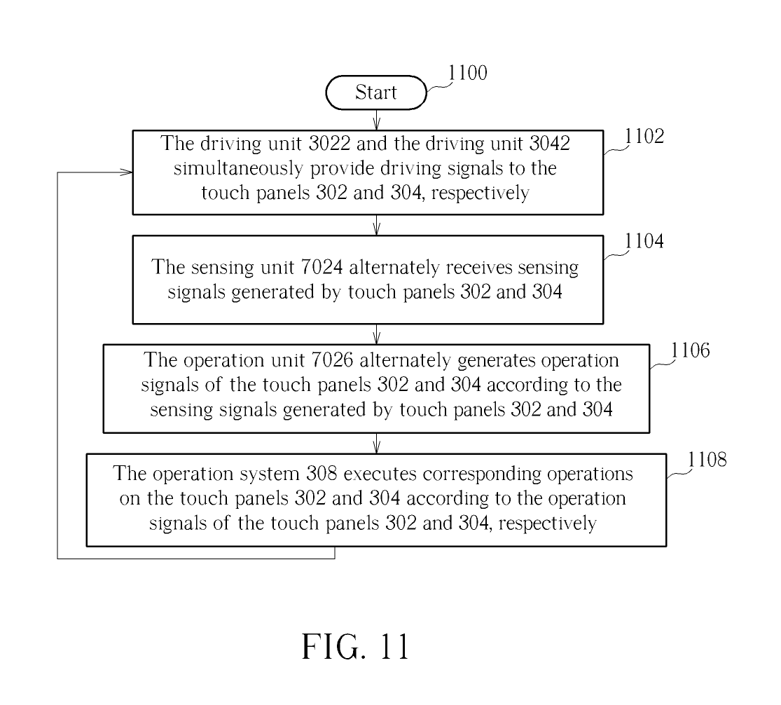

Please refer to FIG. 7 and FIG. 11. FIG. 11 is a flowchart illustrating a method of operating a multi-touch screens device according to another embodiment. The method in FIG. 11 is illustrated using the multi-touch screens device 700 in FIG. 7. Detailed steps are as follows:

Step 1100: Start.

Step 1102: The driving unit 3022 and the driving unit 3042 simultaneously provide driving signals to the touch panels 302 and 304, respectively.

Step 1104: The sensing unit 7024 alternately receives sensing signals generated by touch panels 302 and 304.

Step 1106: The operation unit 7026 alternately generates operation signals of the touch panels 302 and 304 according to the sensing signals generated by touch panels 302 and 304.

Step 1108: The operation system 308 executes corresponding operations on the touch panels 302 and 304 according to the operation signals of the touch panels 302 and 304, respectively; go to Step 1102.

A difference between the embodiment in FIG. 11 and the embodiment in FIG. 9 is that in Step 1104, because the microprocessor 706 only includes the sensing unit 7024, the sensing unit 7024 alternately receives the sensing signals generated by the touch panels 302 and 304; in Step 1106, because the microprocessor 706 only includes the operation unit 7026, the operation unit 7026 can alternately generate the operation signals of the touch panels 302 and 304 according to the sensing signals generated by the touch panels 302 and 304. In addition, subsequent operational principles of the embodiment in FIG. 11 are the same as those of the embodiment in FIG. 9, so further description thereof is omitted for simplicity.

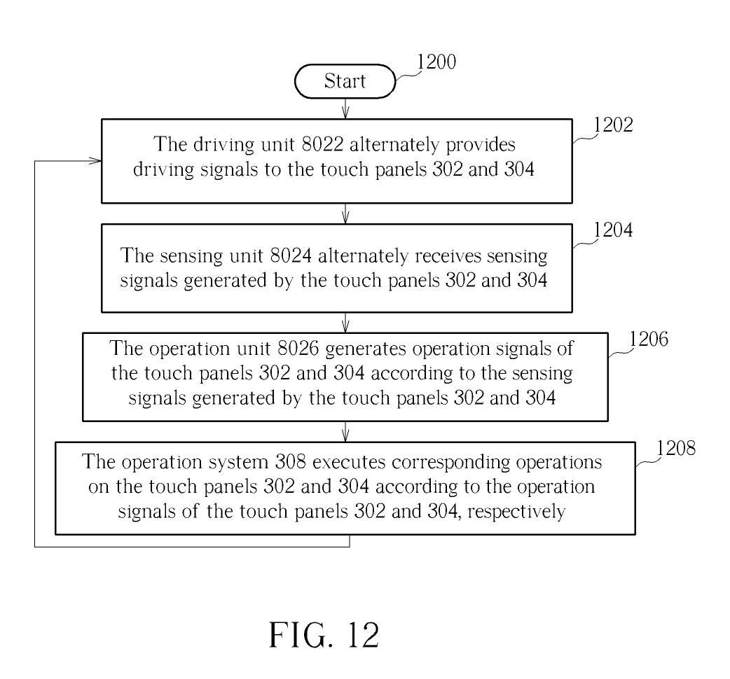

Please refer to FIG. 8 and FIG. 12. FIG. 12 is a flowchart illustrating a method of operating a multi-touch screens device according to another embodiment. The method in FIG. 12 is illustrated using the multi-touch screens device 800 in FIG. 8. Detailed steps are as follows:

Step 1200: Start.

Step 1202: The driving unit 8022 alternately provides driving signals to the touch panels 302 and 304.

Step 1204: The sensing unit 8024 alternately receives sensing signals generated by the touch panels 302 and 304.

Step 1206: The operation unit 8026 generates operation signals of the touch panels 302 and 304 according to the sensing signals generated by the touch panels 302 and 304.

Step 1208: The operation system 308 executes corresponding operations on the touch panels 302 and 304 according to the operation signals of the touch panels 302 and 304, respectively; go to Step 1202.

A difference between the embodiment in FIG. 12 and the embodiment in FIG. 11 is that in Step 1202, because the microprocessor 806 only includes the driving unit 8022, the driving unit 8022 can alternately provide the driving signals of the touch panels 302 and 304 to the touch panels 302 and 304. In addition, subsequent operational principles of the embodiment in FIG. 12 are the same as those of the embodiment in FIG. 11, so further description thereof is omitted for simplicity.

To sum up, the multi-touch screens device and the method provided by the present invention utilize one microprocessor to provide driving signals of at least two touch panels to the at least two touch panels, receive sensing signals generated by the at least two touch panels, and generate operation signals corresponding to the at least two touch panels according to the sensing signals generated by the at least two touch panels. Therefore, compared to the prior art, the present invention has advantages as follows: first, wirings between the microprocessor and the at least two touch panels are significantly decreased; second, because the present invention only includes one microprocessor, the design complexity of the wirings between the microprocessor and the at least two touch panels is lower; third, because the present invention only includes one microprocessor, the present invention has lower cost; and fourth, because the present invention only includes one microprocessor, the present invention has smaller size.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multi-touch screens device, comprising:
at least two touch panels;
a microprocessor coupled to the at least two touch panels for providing driving signals of the at least two touch panels to the at least two touch panels, receiving sensing signals generated by the at least two touch panels, and generating operation signals corresponding to the at least two touch panels according to the sensing signals; and
an operation system coupled to the microprocessor for executing corresponding operations on the at least two touch panels according to the operation signals corresponding to the at least two touch panels.

2. The multi-touch screens device of claim 1, wherein the microprocessor comprises a driving unit, a sensing unit, and an operation unit corresponding to each touch panel of the at least two touch panels, wherein the driving unit is used for providing a driving signal corresponding to the touch panel to the touch panel, the sensing unit is used for receiving a sensing signal generated by the touch panel, and the operation unit is used for generating an operation signal corresponding to the touch panel according to the sensing signal generated by the touch panel.

3. The multi-touch screens device of claim 1, wherein the microprocessor comprises a driving unit corresponding to the at least two touch panels, and a sensing unit and an operation unit corresponding to each touch panel of the at least two touch panels, wherein the driving unit is used for alternately providing the driving signals of the at least two touch panels to the at least two touch panels, the sensing unit is used for receiving a sensing signal generated by the touch panel, and the operation unit is used for generating an operation signal corresponding to the touch panel according to the sensing signal generated by the touch panel.

4. The multi-touch screens device of claim 1, wherein the microprocessor comprises a driving unit corresponding to each touch panel of the at least two touch panels, and a sensing unit and an operation unit corresponding to the at least two touch panels, wherein the driving unit is used for providing a driving signal corresponding to the touch panel to the touch panel, the sensing unit is used for alternately receiving the sensing signals generated by the at least two touch panels, and the operation unit is used for generating the operation signals of the at least two touch panels according to the sensing signals generated by the at least two touch panels.

5. The multi-touch screens device of claim 1, wherein the microprocessor comprises a driving unit, a sensing unit, and an operation unit corresponding to the at least two touch panels, wherein the driving unit is used for alternately providing the driving signals of the at least two touch panels to the at least two touch panels, the sensing unit is used for alternately receiving the sensing signals generated by the at least two touch panels, and the operation unit is used for generating the operation signals of the at least two touch panels according to the sensing signals generated by the at least two touch panels.

6. A method of operating a multi-touch screens device, the multi-touch screens device comprising at least two touch panels, a microprocessor, and an operation system, the method comprising:
the microprocessor providing driving signals of the at least two touch panels to the at least two touch panels;
the microprocessor receiving sensing signals generated by the at least two touch panels;
the microprocessor generating operation signals corresponding to the at least two touch panels according to the sensing signals; and
the operation system executing corresponding operations on the at least two touch panels according to the operation signals corresponding to the at least two touch panels.

7. The method of claim 6, wherein the microprocessor comprises a driving unit, a sensing unit, and an operation unit corresponding to each touch panel of the at least two touch panels, wherein the microprocessor providing the driving signals of the at least two touch panels to the at least two touch panels comprises:
the driving unit providing a driving signal corresponding to the touch panel to the touch panel.

8. The method of claim 7, wherein the microprocessor receiving the sensing signals generated by the at least two touch panels comprises:
the sensing unit receiving a sensing signal generated by the touch panel.

9. The method of claim 8, wherein the microprocessor generating the operation signals corresponding to the at least two touch panels according to the sensing signals comprises:
the operation unit generating an operation signal corresponding to the touch panel according to the sensing signal generated by the touch panel.

10. The method of claim 6, wherein the microprocessor comprises a driving unit corresponding to the at least two touch panels, and a sensing unit and an operation unit corresponding to each touch panel of the at least two touch panels, wherein the microprocessor providing the driving signals of the at least two touch panels to the at least two touch panels comprises:
the driving unit alternately providing the driving signals of the at least two touch panels to the at least two touch panels.

11. The method of claim 10, wherein the microprocessor receiving the sensing signals generated by the at least two touch panels comprises:
the sensing unit receiving a sensing signal generated by the touch panel.

12. The method of claim 11, wherein the microprocessor generating the operation signals corresponding to the at least two touch panels according to the sensing signals comprises:
the operation unit generating an operation signal corresponding to the touch panel according to the sensing signal generated by the touch panel.

13. The method of claim 6, wherein the microprocessor comprises a driving unit corresponding to each touch panel of the at least two touch panels, and a sensing unit and an operation unit corresponding to the at least two touch panels, wherein the microprocessor providing the driving signals of the at least two touch panels to the at least two touch panels comprises:
the driving unit providing a driving signal corresponding to the touch panel to the touch panel.

14. The method of claim 13, wherein the microprocessor receiving the sensing signals generated by the at least two touch panels comprises:
the sensing unit alternately receiving the sensing signals generated by the at least two touch panels.

15. The method of claim 14, wherein the microprocessor generating the operation signals corresponding to the at least two touch panels according to the sensing signals comprises:
the operation unit generating the operation signals of the at least two touch panels according to the sensing signals generated by the at least two touch panels.

16. The method of claim 6, wherein the microprocessor comprises a driving unit, a sensing unit, and an operation unit corresponding to the at least two touch panels, wherein the microprocessor providing the driving signals of the at least two touch panels to the at least two touch panels comprises:
the driving unit alternately providing the driving signals of the at least two touch panels to the at least two touch panels.

17. The method of claim 16, wherein the microprocessor receiving the sensing signals generated by the at least two touch panels comprises:
the sensing unit alternately receiving the sensing signals generated by the at least two touch panels.

18. The method of claim 17, the microprocessor generating the operation signals corresponding to the at least two touch panels according to the sensing signals comprises:
the operation unit generating the operation signals of the at least two touch panels according to the sensing signals generated by the at least two touch panels.
